(19) United States
(12) Patent Application Publication
(10) Pub. No.: US 2019/0197617 A1
(43) Pub. Date: Jun. 27, 2019

(54) METHODS FOR OFFERING A CREDIT, CREDIT OFFER SERVERS, AND COMPUTER READABLE MEDIA

(71) Applicant: MASTERCARD INTERNATIONAL INCORPORATED, Purchase, NY (US)

(72) Inventor: Gautam Chopra, New Delhi (IN)

(21) Appl. No.: 16/225,053

(22) Filed: Dec. 19, 2018

(30) Foreign Application Priority Data
Dec. 22, 2017 (SG) 10201710766S

(51) Int. Cl. G06Q 40/02; G06Q 20/24; G06Q 20/26

(52) U.S. Cl. CPC G06Q 40/025; G06Q 20/26; G06Q 20/24

(57) ABSTRACT

According to various embodiments, a method for offering a credit may be provided. The method may include: determining an initial credit limit of a payment card based on a first set of data associated with a cardholder of the payment card, receiving payment instructions based on usage of a payment card; dynamically determining an updated credit limit of the payment card based on the initial credit limit and a second set of data; and offering a credit based on the updated credit limit.

### FIELD OF INVENTION

The present invention relates broadly, but not exclusively, to methods for offering a credit, credit offer servers, and computer readable media.

### BACKGROUND

Payment cards, such as credit cards and debit cards, are widely used by consumers to settle transactions. Increasing demand and improved benefits on the debit card products in most of the economies are resulting in a loss of credit card consumer base to debit cards, as more and more consumers are using debit cards to avoid potential extra charges on a small number of purchases.

A conventional debit card is normally linked to a bank account with an available balance from which funds are drawn during a transaction. However, there can be situations where the value of the transaction may exceed the available balance, and the debit cannot be made, thus limiting usage of the card and potentially frustrating the consumer.

A need therefore exists to enhance the user experience for payment cards in general and debit cards in particular.

### SUMMARY

According to various embodiments, a method for offering a credit may be provided. The method may include: determining an initial credit limit of a payment card based on a first set of data associated with a cardholder of the payment card, receiving payment instructions based on usage of a payment card; dynamically determining an updated credit limit of the payment card based on the initial credit limit and a second set of data; and offering a credit based on the updated credit limit.

According to various embodiments, a credit offer server may be provided. The credit offer server may include: a receiver configured to receive payment instructions based on usage of a payment card; a determination circuit configured to determine an initial credit limit of the payment card based on a first set of data associated with a cardholder of the payment card, and to dynamically determine an updated credit limit of the payment card; and a transmitter configured to transmit an offer of a credit based on the updated credit limit.

According to various embodiments, a computer readable medium may be provided. The computer-readable medium may include instructions which, when executed by a processor, make the processor perform a method for offering a credit. The method may include: determining an initial credit limit of a payment card based on a first set of data associated with a cardholder of the payment card, receiving payment instructions based on usage of a payment card; dynamically determining an updated credit limit of the payment card based on the initial credit limit and a second set of data; and offering a credit based on the updated credit limit.

### BRIEF DESCRIPTION OF DRAWINGS

Embodiments and implementations are provided by way of example only, and will be better understood and readily apparent to one of ordinary skill in the art from the following written description, read in conjunction with the drawings, in which:

FIG. 1A shows a flow diagram illustrating a method for offering a credit according to various embodiments;

FIG. 1B shows a credit offer server according to various embodiments;

FIG. 2 shows an illustration of a first logistic model; and

FIG. 3 shows an illustration of a second logistic model.

FIG. 4 shows a schematic diagram of a computing device suitable for implementing the method and system of according various embodiments.

### DETAILED DESCRIPTION

### Overview

The present disclosure provides methods and systems which may allow a consumer to borrow money against an existing checking/savings account. The credit may be requested from the bank or the account may automatically offer the consumer a default credit limit. The credit limit may be dynamically updated. A payment card using the present methods and system may also offer a dynamic withdrawal limit on the debit transaction in markets having governmental regulations on withdrawal.

The methods and systems as disclosed thus may enable a product in the form of a smart credit and debit card providing a dynamic spending limit for each type of consumer. This may be executed in multiple ways under different business scenarios. For example, a consumer using a payment card at a POS terminal may have an option to select between the credit or debit mode for funds usage and, after selection of the same, the consumer may be able to withdraw funds from a checking account or borrow credit from the bank at a nominal interest rate.

According to various embodiments, a user may use a payment card. The payment card may have an initial credit limit determined based on a first set of data associated with the user (a cardholder of the payment card). Upon receiving payment instructions based on the usage of the payment card, the card issuer may determine an updated credit limit of the payment card based on the initial credit limit and a second set of data. The user may then be offered a credit based on the updated credit limit. The updated credit limit may be determined dynamically. For example, the card issuer may, together with the payment instructions, receive more detailed information on the purchase, and may determine the credit limit based on an item (or a type of the item) purchased, or based on a shop or merchant (or a type of shop or type of merchant). Furthermore, the credit limit may be determined based on age, income, gender, designation, CIBIL score, SSID, city tier of residence, and/or number of dependents of a holder of the payment card, and/or based on a probability of default and/or based on an exposure at default.

As such, according to various embodiments, a debit card alone may incorporate functions of both a debit card and a credit card, i.e. a one-stop solution for both types of transaction, and a user may not have different cards, which may increase the user experience. Furthermore, having only one type of card may decrease management efforts for the card issuer.

Due to determining the credit limits dynamically and tailored to the actual use of the card and the situations of the user and the purchase, fraudulent use may be minimized. Instead of setting an overall credit limit, that may be prone to fraudulent use, the credit limit is dynamically set, and may be higher for use cases that are less prone to fraudulent use, and may be lower for transactions with a high risk of fraudulent use.

### Terms Description (in Addition to Plain and Dictionary Meaning of Terms)

A credit is a value (e.g. monetary value) that a lender provides to a borrower/debtor. A credit limit is the maximum amount of credit that the lender is willing to extend to the borrower/debtor for a particular line of credit.

A credit score (or example CIBIL score) of a user is an evaluation of the creditworthiness of the user. The credit score for example is a number, wherein for example a lower number indicates a lower creditworthiness. For example, a credit score of 0 indicates that the user is not creditworthy at all. For example, a credit score of 100 is the best credit score available. Other than expressing the credit score by a number, the credit score can also be expressed in terms of plain text description (for example ‘not creditworthy’, ‘medium creditworthy’, ‘above average creditworthy’).

A payment instruction may be information including an amount and a payee, and may be received by an issuer of a card, for payment of a purchase in a store or at a merchant (which may be an offline merchant or an online merchant, i.e. internet based merchant).

A payment card may be any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. In other words, in some instances, such a payment card may not exist in a physical form, but rather, may be in an electronic form comprising data stored in a digital (i.e. mobile) wallet.

Probability of default (PD) may be the risk that the borrower will be unable or unwilling to repay its debt in full or on time. The risk of default is derived by analyzing the obligor's capacity to repay the debt in accordance with contractual terms.

Exposure at default (EAD) is a parameter used in the calculation of economic capital or regulatory capital under Basel II for a banking institution. It can be defined as the gross exposure under a facility upon default of an obligor.

A credit offer server may be a server, for example provided at an card issuer or at a bank, which may receive a payment request, and which may dynamically determine a credit limit based on the payment request and based on the circumstances of the payment (for example based on details of the payer, and/or based on details of what the payment is for, and/or based on details of the shop or merchant where the payment is to be made).

### Exemplary Embodiments

Embodiments will be described, by way of example only, with reference to the drawings. Like reference numerals and characters in the drawings refer to like elements or equivalents.

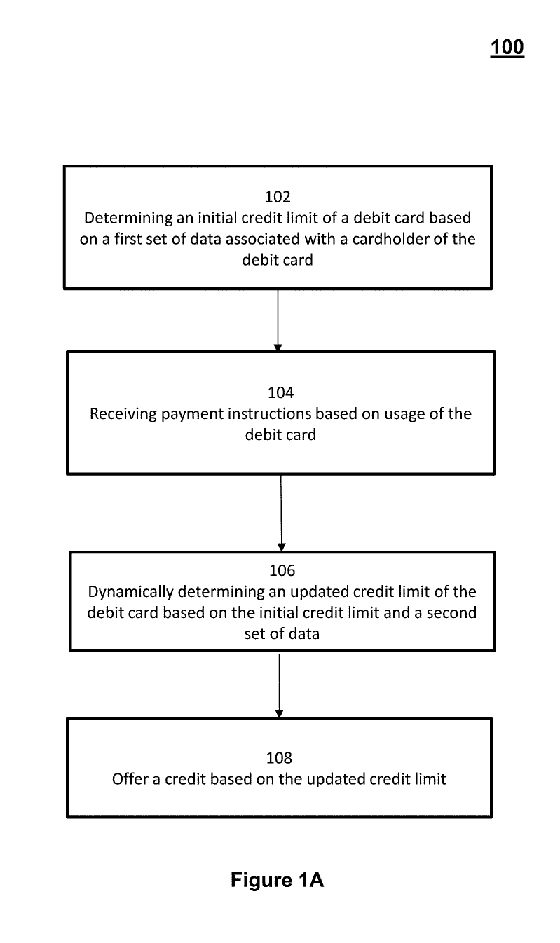

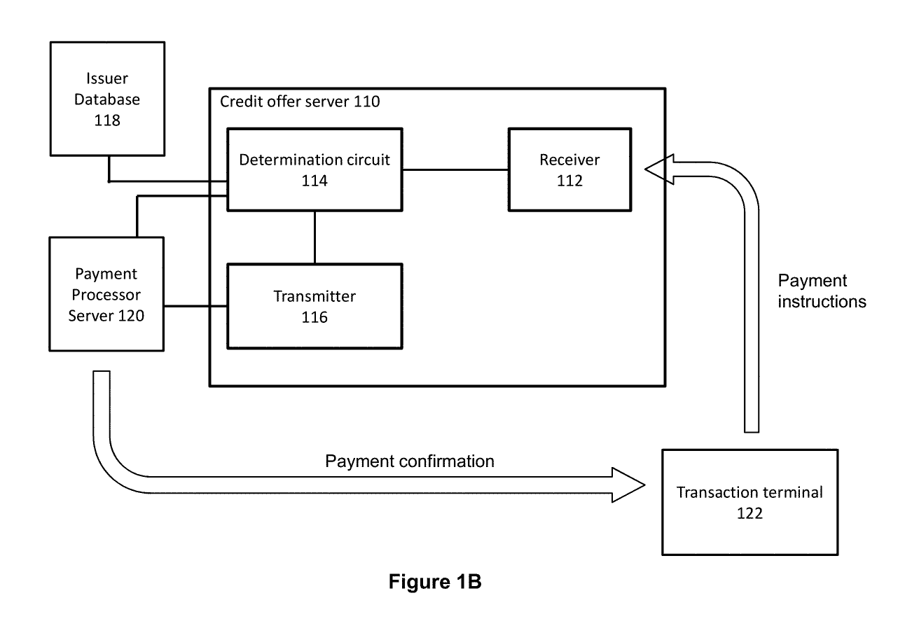

FIG. 1A shows a flowchart 100 illustrating a method for offering a credit according to an example embodiment. At step 102, an initial credit limit of a payment card is determined based on a first set of data associated with a cardholder of the payment card. Typically, the first set of data may include data provided at the time of the cardholder applying for the payment card or opening an account with a financial institution, as part of know-your-customer (KYC) requirements. Non-limiting examples of such data include identification number, age, gender, occupation, income, primary residence, etc. of the cardholder. The financial institution may also obtain additional data from other sources, e.g. credit score of the cardholder, value of primary residence of the cardholder, etc. At step 104, payment instructions based on usage of the payment card is received. For example, the payment instructions may originate from a point-of-sale (POS) terminal during a transaction. The payment instructions may indicate that the cardholder wishes to process the transaction by credit mode, instead of debit mode. At step 106, an updated credit limit of the payment card is dynamically determined based on the initial credit limit and a second set of data. The second set of data may include a probability of default and an exposure at default. For example, the probability of default may be determined based on at least one of a spending and payback pattern, demographic data and macroeconomic data associated with the cardholder of the payment card. The exposure at default may be determined based on product data and/or merchant data in the payment instructions. For example, product data indicating a low purchase price may mean a low exposure at default. At step 108, a credit is offered based on the updated credit limit. For example, if it is determined that the cardholder is well within the updated credit limit, a credit equal to the value of the transaction is provided to the cardholder to settle the transaction. Optionally, the spending history is updated after completion of the transaction so that a future use of the payment card can take into account the transaction just performed.

The above method may be embodied or implemented in a physical system. FIG. 1B shows a schematic diagram of a credit offer server 110 including a receiver 112, a determination circuit 114 and a transmitter 116. The credit offer server 110 may be maintained by a financial institution, e.g. an Issuer bank that issues the payment card as described herein. The determination circuit 114 is communicatively coupled to both the receiver 112 and transmitter 116. In addition, the determination circuit 114 is communicatively coupled to a database 118 (e.g. one maintained by the financial institution) that stores data associated with the cardholder, and to a payment processor server 120 (e.g. a server maintained by a payment card network such as Mastercard®). The receiver 112 is configured to receive payment instructions based on usage of a payment card. For example, the payment instructions may be transmitted over a network, e.g. the Internet, from a transaction terminal 122 (e.g. a POS terminal or an ATM) in connection with a transaction being made at the payment terminal 122. The determination circuit 114 is configured to determine an initial credit limit of the payment card based on a first set of data associated with a cardholder of the payment card, and to dynamically determine an updated credit limit of the payment card based on the initial credit limit and a second set of data. The first set of data may be retrieved from the database 118, while the second set of data may be retrieved from the database 118 as well as the payment instructions. The transmitter 116 is configured to transmit an offer of a credit based on the updated credit limit. In one implementation, the transmitter 116 may instruct the payment processor server 120 to process the payment, and the payment processor server 120 may communicate a confirmation to the transaction terminal 122 if the transaction is authorized. Alternatively, the transmitter 116 can communicate with the transaction terminal 122 after receiving confirmation from the payment processor server 120.

Based on the method and system as described, a new product, which may be a payment card mapped to an account at an issuer bank, may be provided. The card may offer a dynamic credit limit. The credit limit may be decided as per a risk assessment score provided by the predictive risk models running in the back end capturing the overall attributes of the consumer provided at the time of opening the account. This may be different from the overdraft as it is a credit limit being offered on the card and not the account that the user can access only after visiting the issuer retail branch.

For example, a consumer X may be issued a debit/ATM (automatic teller machine) card at the time of account opening to access its deposited funds. The issuer, based on attributes including but not limited to CIBIL score, current account balance, customer demographics, and income information, may attach an initial credit limit on the payment card provided to the consumer. The consumer may select any of Credit/Debit option to make the payments at POS terminals or ATM withdrawals. If the consumer selects the Debit option, funds are drawn from the account to settle the transaction. On the other hand, if the consumer selects the Credit option, a credit may be offered to the consumer based on the method as described above with respect to FIG. 1A.

According to various embodiments, a card product may be provided with a dynamic credit limit being periodically updated (for example, daily or weekly) to save the consumer from the hassle of worrying about its credit limit. Alternatively or in addition, the credit limit may be dynamically updated at each use of the card.

According to various embodiments, a dynamic credit limit may be provided, and this may be implemented as described in the following.

According to various embodiments, different limits may be tested with large samples (e.g. thousands of prospective customers) and compared against random control offers. By measuring the impact of different limits and segmenting the result by criteria like credit scores, the right limit may be determined for each type of customer to maximize revenue and minimize default. The scenario may be executed by incorporating two different frameworks, namely, probability of default and exposure at default.

In the present method and system, a predictive model is built to determine the probability of default. According to various embodiments, steps to develop the overall probability of default predictive mechanism may include:

Data Gathering;

Data Cleaning and Structuring;

Exploratory Data Analysis—Shortlist Variables;

Variable reduction—PCA analysis, Weight of evidence, information Value;

Selection of best fit model variables; and

Design and refinement of final logistics equation.

Characteristics which may generally be indicative of the probability of default may include but are not limited to inadequate cash flow to service debt, declining revenues or operating margins, high leverage, declining or marginal liquidity, and/or inability to successfully implement a business plan. In addition to these quantifiable factors, the borrower's willingness to repay also must be evaluated.

It has also been noted that the Probability of default not only depends on the risk characteristics but also on the macro economic factors affecting the risk characteristics of the consumer. In example embodiments, the macroeconomic data associated with the consumer (i.e. cardholder) are used to dynamically update the credit limit.

The macro economic factors may be House price indices, unemployment, GDP growth, for example.

The probability of default may be estimated by using logistic regression technique with the incorporation of parameters discussed above. For example, the source of risk-related variables may be derived from the consumer historical spend pattern and demographic data. Whereas, the macro economic data may be incorporated from the sources such as Euromonitor international passport.

As described above, the variables of the best-fit model may include at least one of a spending and payback pattern, demographic data and macroeconomic data associated with the cardholder of the payment card. After the variables are identified, possible models are considered. In the process of considering the alternative models, it has been noted that a linear probability model encounters problems with predicted probabilities. In example embodiments, a logistic regression model is used to obtain the probabilities. The “log it” model (in other words: logistic regression model) is selected as it can solve these problems.

The logistic regression model can take the form of:

ln[p/(1−p)]=a+BX+e or

[p/(1−p)]=exp(a+BX+e),

where:

In is the natural logarithm, log exp, where exp=2.71828 . . . ;

p is the probability that the event Y occurs, p(Y=1);

p/(1−p) is the “odds ratio”;

ln[p/(1−p)] is the log odds ratio, or “log it”;

a is the coefficient on the constant term;

B is the coefficient(s) on the independent variable(s);

X is the independent variable(s); and

e is the error term.

The final function ln[p/(1−p)] may output a probability with the event that whether a customer will default or not.

Next, the exposure at default is determined.

The Exposure at default (EAD) is seen as an estimation of the extent to which a bank may be exposed to a counterparty in the event of, and at the time of, that counterparty's default. EAD is equal to the current amount outstanding in case of fixed exposures such as term loans. For revolving exposures like lines of credit, EAD can be divided into drawn and undrawn commitments; typically the drawn commitment is known whereas the undrawn commitment needs to be estimated to arrive at a value of EAD.

In one non-limiting example, the exposure at default is determined based on the product data associated with the transaction, e.g. value of a transaction. A high value transaction would be indicative of a higher exposure at default, as compared to a low value transaction. In another non-limiting example, the exposure at default is determined based on merchant data associated with the transaction, e.g. merchant category code. For certain merchant categories, based on regulations or safeguards, it may be possible to recover some losses in the event of a default, hence reducing exposure, whereas for other categories, it may not be possible.

An overall framework equation according to various embodiments may be:

Probability of default=1/Exposure at default

Both parameters may play a simultaneous role in terms of adjusting the overall credit limit. For example, if the probability of default is high, the credit limit is updated such that the exposure at default is reduced or minimized.

According to various embodiments, the present methods and systems can be applied in markets having regulations on a withdrawal limit (e.g. a daily maximum withdrawal limit), such that the credit limit does not exceed the withdrawal limit of a debit card, as described herein.

For example, Customer X visits the bank to open a new account. The customer has to provide various demographics as well KYC (know your customer) details to open the account.

A logistic regression model may predict the probability of customer being offered (i.e. achieving) the maximum limit being regulated by the government and the customer can be offered an initial credit limit the accordingly, such that the initial credit limit does not exceed the maximum limit.

This may be the limit of default of being offered to the customer. As the Customer X moves in to the system and starts spending through the payment card, the limit can be modified accordingly by using a second logistic based model.

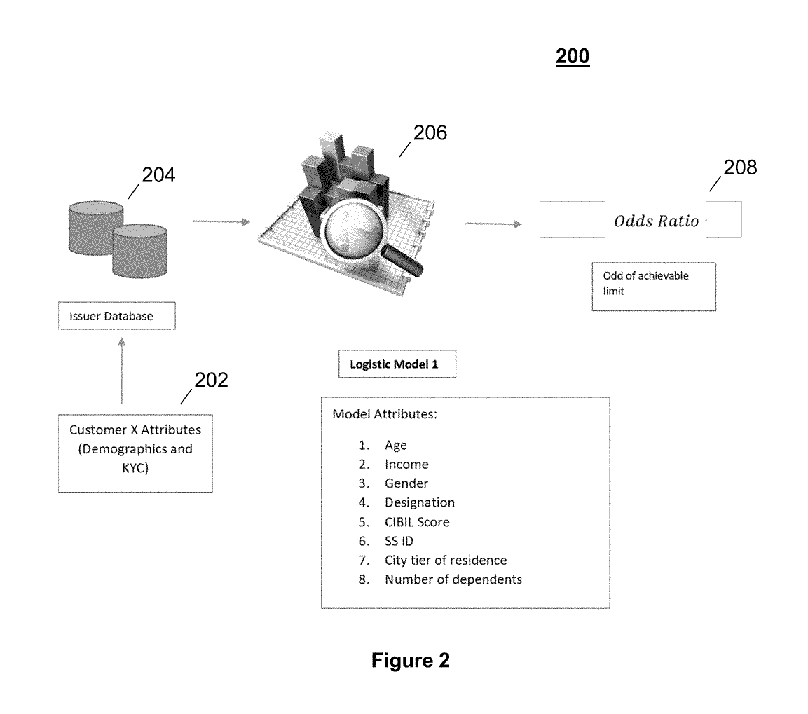

FIG. 2 shows an illustration 200 of a first logistic model (“logistic model 1”). Attributes 202 of Consumer X may be provided in an issuer database 204, and may be used by the first logistic model 206 to determine an odds ratio 208. The model attributes may include age, income, gender, designation, CIBIL score, SSID, city tier of residence, and/or number of dependents.

The default limit may be determined as follows:

Default(achievable)Withdrawal Limit=Odds of achievable limit*Maximum Withdrawal Limit.

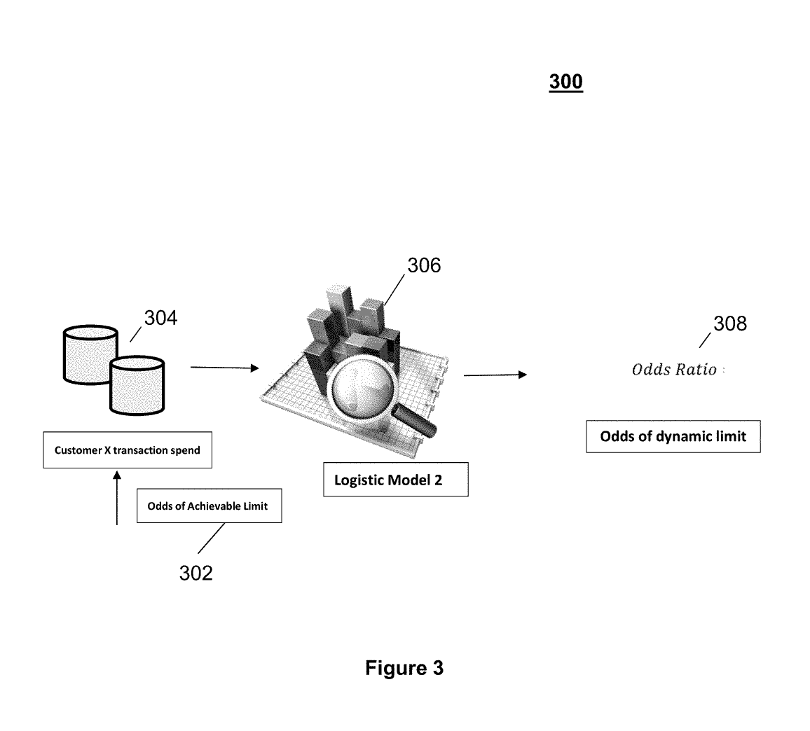

FIG. 3 shows an illustration 300 of a second logistic model (“logistic model 2”). Odds of achievable limit 302, such as those described above with reference to FIG. 2, may be provided in a database 304 which also stores information on consumer X's transaction spendings. These data may be provided to a second logistic model 306, which may determine an odds of dynamic limit 308. For example, the customer X's transaction spendings can include data associated with the current and past transactions, e.g. product data (e.g. product category, price, etc.), merchant data (e.g. merchant category code, merchant location, etc.), which can be retrieved from a payment request message. The second logistic model 306 takes these data into account and dynamically determines the withdrawal limit. For example, the limit may be set higher for certain categories as compared to others.

The dynamic limit may be determined as follows:

Dynamic Withdrawal Limit=Odds of dynamic limit*Maximum Withdrawal Limit.

According to various embodiments, the limits may be changed on a real time basis. The limits may be further based on the overall spending and payback pattern of the consumer using the product. The data collected from these pillars may be utilized to change these limits without taking consumer approval and not making the consumer worry about the approval limit while spending.

The product may also have different spend limits under different merchant categories based on their spend behavior. For example, product data such as transaction amount and type of transaction and/or merchant data such as merchant category code or industry code, can be used to determine the exposure at default, hence the updated credit limit.

The rewards and benefits being offered to the consumer may be customized and offered based on their category of spend.

The dynamic debit withdrawal limit may be applicable to regulated economies like India. As described, both the initial credit limit and the updated credit limit cannot exceed the maximum withdrawal limit, thereby ensuring that a debit card according to example embodiments complies with government regulations.

The product may be a win-win situation for both Issuer as well as the customer offering complete debit and debit features under a single product umbrella. The issuer may be having a flexibility to offer customization to this product based on the business model applications in different markets and government regulations.

Some portions of the description herein are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the description herein, it will be appreciated that throughout the present specification, discussions utilizing terms such as “receiving”, “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer suitable for executing the various methods/processes described herein will appear from the description herein.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

According to various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

It will be understood that functionality of one or more circuits may be combined in a single circuit or split up into several circuits.

Various features are described for a device, but may analogously also be provided for a method, and vice versa.

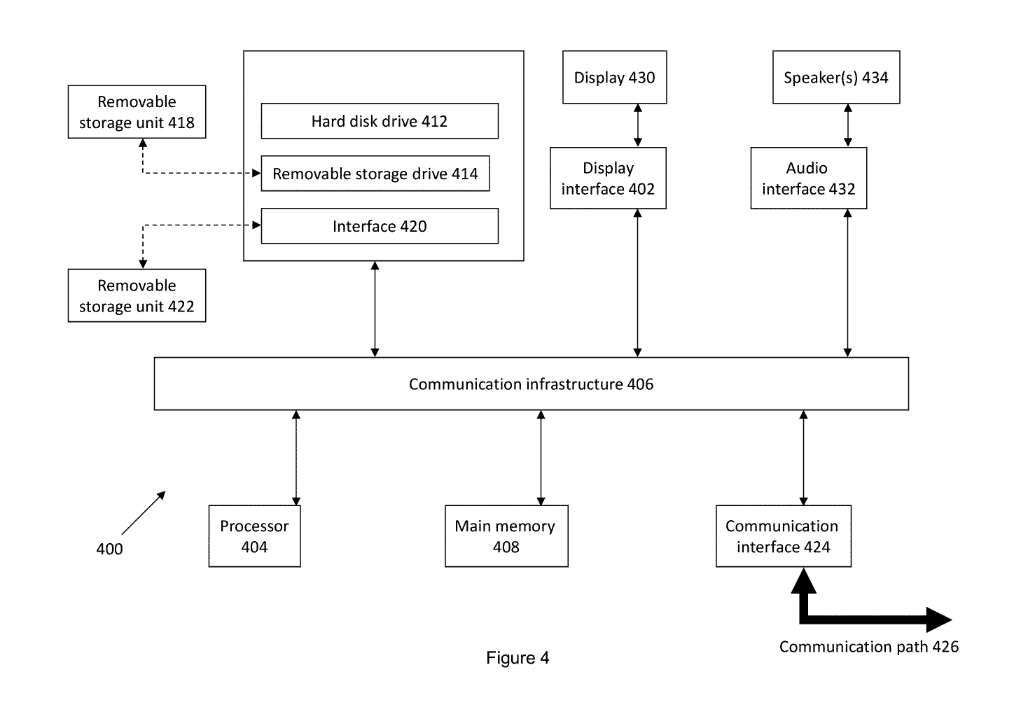

FIG. 4 depicts an exemplary computing device 400, hereinafter interchangeably referred to as a computer system 400, where one or more such computing devices 400 may be used for the credit offer server 110 (FIG. 1B). The following description of the computing device 400 is provided by way of example only and is not intended to be limiting.

As shown in FIG. 4, the example computing device 400 includes a processor 404 for executing software routines. Although a single processor is shown for the sake of clarity, the computing device 400 may also include a multi-processor system. The processor 404 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a hard disk drive 412 and/or a removable storage drive 414, which may include a floppy disk drive, a magnetic tape drive, an optical disk drive, or the like. The removable storage drive 414 reads from and/or writes to a removable storage unit 418 in a well-known manner. The removable storage unit 418 may include a floppy disk, magnetic tape, optical disk, or the like, which is read by and written to by removable storage drive 414. As will be appreciated by persons skilled in the relevant art(s), the removable storage unit 418 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 420. Examples of a removable storage unit 422 and interface 420 include a program cartridge and cartridge interface (such as that found in video game console devices), a removable memory chip (such as an EPROM or PROM) and associated socket, and other removable storage units 422 and interfaces 420 which allow software and data to be transferred from the removable storage unit 422 to the computer system 400.

The computing device 400 also includes at least one communication interface 424. The communication interface 424 allows software and data to be transferred between computing device 400 and external devices via a communication path 426. In various embodiments of the inventions, the communication interface 424 permits data to be transferred between the computing device 400 and a data communication network, such as a public data or private data communication network. The communication interface 424 may be used to exchange data between different computing devices 400 which such computing devices 400 form part an interconnected computer network. Examples of a communication interface 424 can include a modem, a network interface (such as an Ethernet card), a communication port, an antenna with associated circuitry and the like. The communication interface 424 may be wired or may be wireless. Software and data transferred via the communication interface 424 are in the form of signals which can be electronic, electromagnetic, optical or other signals capable of being received by communication interface 424. These signals are provided to the communication interface via the communication path 426.

As shown in FIG. 4, the computing device 400 further includes a display interface 402 which performs operations for rendering images to an associated display 430 and an audio interface 432 for performing operations for playing audio content via associated speaker(s) 434.

As used herein, the term “computer program product” may refer, in part, to removable storage unit 418, removable storage unit 422, a hard disk installed in hard disk drive 412, or a carrier wave carrying software over communication path 426 (wireless link or cable) to communication interface 424. Computer readable storage media refers to any non-transitory tangible storage medium that provides recorded instructions and/or data to the computing device 400 for execution and/or processing. Examples of such storage media include floppy disks, magnetic tape, CD-ROM, DVD, Blu-Ray™ Disc, a hard disk drive, a ROM or integrated circuit, USB memory, a magneto-optical disk, or a computer readable card such as a PCMCIA card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites and the like.

The computer programs (also called computer program code) are stored in main memory 408 and/or secondary memory 410. Computer programs can also be received via the communication interface 424. Such computer programs, when executed, enable the computing device 400 to perform one or more features of embodiments discussed herein. In various embodiments, the computer programs, when executed, enable the processor 404 to perform features of the above-described embodiments. Accordingly, such computer programs represent controllers of the computer system 400.

Software may be stored in a computer program product and loaded into the computing device 400 using the removable storage drive 414, the hard disk drive 412, or the interface 420. Alternatively, the computer program product may be downloaded to the computer system 400 over the communications path 426. The software, when executed by the processor 404, causes the computing device 400 to perform functions of embodiments described herein.

It is to be understood that the embodiment of FIG. 4 is presented merely by way of example. Therefore, in some embodiments one or more features of the computing device 400 may be omitted. Also, in some embodiments, one or more features of the computing device 400 may be combined together. Additionally, in some embodiments, one or more features of the computing device 400 may be split into one or more component parts.

It will be appreciated that the elements illustrated in FIG. 4 function to provide means for performing the various functions and operations of the servers as described in the above embodiments.

In an implementation, a server may be generally described as a physical device comprising at least one processor and at least one memory including computer program code. The at least one memory and the computer program code are configured to, with the at least one processor, cause the physical device to perform the requisite operations.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for offering a credit, the method comprising:
determining an initial credit limit of a payment card based on a first set of data associated with a cardholder of the payment card;
receiving payment instructions based on usage of the payment card;
dynamically determining an updated credit limit of the payment card based on the initial credit limit and a second set of data; and
offering a credit based on the updated credit limit.

2. The method of claim 1, wherein the payment card comprises a maximum withdrawal limit, and wherein the initial credit limit is determined based on a probability of the cardholder of the payment card being offered the maximum withdrawal limit such that the initial credit limit does not exceed the maximum withdrawal limit.

3. The method of claim 2, wherein the probability of the cardholder of the payment card being offered the maximum withdrawal limit is determined based on at least one of age, income, gender, designation, CIBIL score, SSID, city tier of residence, and number of dependents of the cardholder of the payment card.

4. The method of claim 2, wherein the probability of the cardholder of the payment card being offered the maximum withdrawal limit is determined using a first logistic regression model.

5. The method of claim 1, wherein the second set of data comprise a probability of default.

6. The method of claim 5, wherein the probability of default is determined based on at least one of a spending and payback pattern, demographic data and macroeconomic data associated with the cardholder of the payment card.

7. The method of claim 5, wherein the probability of default is determined using a second logistic regression model.

8. The method of claim 1, wherein the second set of data comprise an exposure at default.

9. The method of claim 8, wherein the exposure at default is determined based on product data related to the payment instructions.

10. The method of claim 8, wherein the exposure at default is determined based on merchant data related to the payment instructions.

11. A credit offer server comprising:
a receiver configured to receive payment instructions based on usage of a payment card;
a determination circuit configured to determine an initial credit limit of the payment card based on a first set of data associated with a cardholder of the payment card, and to dynamically determine an updated credit limit of the payment card based on the initial credit limit and a second set of data; and
a transmitter configured to transmit an offer of a credit based on the updated credit limit.

12. The credit offer server of claim 11, wherein the payment card further comprises a maximum withdrawal limit, and wherein the determination circuit is configured to determine the initial credit limit based on a probability of the cardholder of the payment card being offered the maximum withdrawal limit, such that the initial credit limit does not exceed the maximum withdrawal unit.

13. The credit offer server of claim 12, wherein the determination circuit is further configured to determine the probability of the cardholder of the payment card being offered the maximum withdrawal limit based on at least one of age, income, gender, designation, CIBIL score, SSID, city tier of residence, and number of dependents of the cardholder of the payment card.

14. The credit offer server of claim 12, wherein the determination circuit is further configured to determine the probability of the cardholder of the payment card being offered the maximum withdrawal limit using a first logistic regression model.

15. The credit offer server of claim 11, wherein the determination circuit is further configured to determine a probability of default based on at least one of a spending and payback pattern, demographic data and macroeconomic data associated with the cardholder of the payment card.

16. The credit offer server of claim 11, wherein the determination circuit is further configured to determine a probability of default using a second logistic regression model.

17. The credit offer server of claim 11, wherein the second set of data comprise an exposure at default.

18. The credit offer server of claim 17, wherein the determination circuit is further configured to determine the exposure at default based on product data related to the payment instructions.

19. The credit offer server of claim 17, wherein the determination circuit is further configured to determine the exposure at default based on merchant data related to the payment instructions.

20. A non-transitory computer readable medium comprising instructions which, when executed by a processor, make the processor perform a method for offering a credit, the method comprising:
determining an initial credit limit of a payment card based on a first set of data associated with a cardholder of the payment card;
receiving payment instructions based on usage of the payment card;
dynamically determining an updated credit limit of the payment card based on the initial credit limit and a second set of data; and
offering a credit based on the updated credit limit.
